(19) United States
(12) Patent Application Publication
(10) Pub. No.: US 2005/0045750 A1
(43) Pub. Date: Mar. 3, 2005

(54) Monodisperse nozzle

(76) Inventor: Zeljko Prebeg, Zagreb (HR)

Correspondence Address: ZELJKO PREBEG, LERMANOVA 12A, ZAGREB, 10000, HR

(21) Appl. No.: 10/648,691

(22) Filed: Aug. 26, 2003

(51) Int. Cl. B05B 1/26; B05B 1/34; B05B 15/08

(52) U.S. Cl. 239/587.1; 239/602

(57) ABSTRACT

Monodisperse nozzle produces the spray where droplets are of the same size. Advantages of this nozzle are circular outlet what prevents blockage of the nozzle and flexible slit width what gives opportunity for adjustment of the drop size and flow rate. The principle of the construction of the monodisperse nozzle is calotte placed in the conical outlet what causes specific flow of liquid. Separate streams are formed what leads in production of the monodisperse spray. Axial position of the calotte can be adjusted by winding of the stem for which calotte is connected while screws placed on the head of the nozzle can adjust radial position of the calotte.

### BACKGROUND OF THE INVENTION

Monodisperse nozzle produces monodisperse spray. Such a spray consists droplets of the same size. Today, monodisperse spray can be produced with the multihole nozzle (shower) but this kind of technology has some disadvantages. Dimension of the holes are fixed and holes have a tendency to be blocked. Another way for producing of the monodisperse spray is vibration excitation of the liquid sheet, but for that, vibration exciter is necessary. The main aim of this invention is to produce monodisperse spray without these disadvantages.

### BRIEF SUMMARY OF THE INVENTION

General idea for this invention is based on the specific flow of liquid over the spherical surface. Outlet of the nozzle is formed between the sphere and conical exit of the pipe. Sphere is cut out in the shape of calotte with sharp edges to prevent pouring. Liquid passing trough this outlet and forms liquid streams. Each of this streams finally breaks onto the droplets of the same size. Distance between sphere and conical exit can be adjusted what has an effect on the shape of the spray and size of the droplets. Three screws placed on the head of the nozzle changes radial position of the calotte. With this, symmetrical flow can be adjusted.

### BRIEF DESCRIPTION OF THE SEVERAL VIEWS OF THE DRAWING

FIG. 1 shows monodisperse nozzle with signed parts

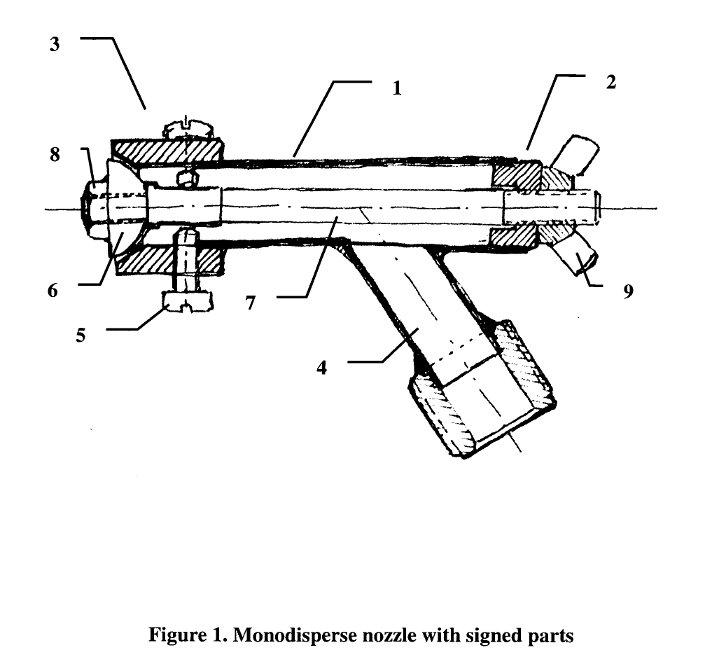

FIG. 2 shows principle of the construction of the monodisperse nozzle

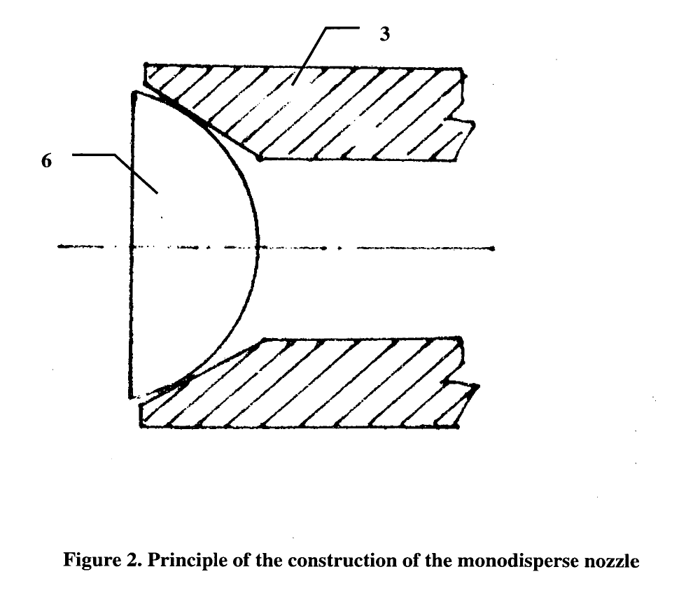

### DETAILED DESCRIPTION OF THE INVENTION

On the one side of the pipe (1) nut (2) is soldered while on the second side head (3) is winded. Inlet of the liquid in the nozzle is realized with another pipe with threat (4), which is soldered under some angle for the pipe (1). On the head (3) three screws (5) are symmetrically placed. Screws (5) are using for estimation of centricity of the calotte (6). Outlet of head is realized in the form of cones where calotte is placed. Calotte is winded on the stem (7). On the bottom one nut (8) is soldered while second side of the stem is winded on the nut (2). On the top of the nozzle one nut (9) exist. Role of this nut is blocking of the axial position of the calotte.

Monodisperse nozzle operates on that way that liquid is supplyed on the pipe (4). By the winding of the nut (8), distance between calotte (6) and cones can be estimate what makes influence on the drop size and flow rate of the liquid. Symmetry of the flow can be estimate with the screws (5). Well-estimated nozzle produces many streams of the droplets from its outlet.

1. Outlet of the nozzle is made from calotte (6), which is placed in the conical outlet of the head (3).
